(19) United States
(12) Patent Application Publication
(10) Pub. No.: US 2015/0153714 A1
(43) Pub. Date: Jun. 4, 2015

(54) RENEWABLE ENERGY POWER GENERATION PREDICTION SYSTEM AND METHOD AND POWER ALLOCATION SYSTEM

(71) Applicant: Institute For Information Industry, Taipei (TW)

(72) Inventor: Tzong-Hsien HO, Taipei City (TW)

(73) Assignee: INSTITUTE FOR INFORMATION INDUSTRY, Taipei (TW)

(21) Appl. No.: 14/101,360

(22) Filed: Dec. 10, 2013

(30) Foreign Application Priority Data
Nov. 29, 2013 (TW) 102143794

(51) Int. Cl. G05B 13/02; G06N 99/00

(52) U.S. Cl. CPC G05B 13/02; G06N 99/005

(57) ABSTRACT

A renewable energy power generation prediction system includes a measuring module and a control module. The measuring module is configured for measuring power generated by at least one renewable energy power generator and outputting a plurality of historical power values. The control module includes a computing unit and a machine-learning unit. The computing unit is configured for computing a plurality of historical power variations according to the historical power values. The machine-learning unit is configured for estimating a predicted power value according to the historical power variations. A renewable energy power generation prediction method and a power allocation system are disclosed herein as well.

### RELATED APPLICATIONS

This application claims priority to Taiwan Application Serial Number 102143794, filed Nov. 29, 2013, which is herein incorporated by reference.

### BACKGROUND

1. Technical Field

The present disclosure relates to a prediction system and method. More particularly, the present disclosure relates to a renewable energy power generation prediction system, a renewable energy power generation prediction method, and a power allocation system

2. Description of Related Art

Renewable energy power generation prediction systems are used for predicting values of power generated by renewable energy power generators, and which could also be used to allocate the power supply of power networks according to the predicted power values.

However, current skills consider many factors at the same time, for example: environmental factors including sunshine, temperature, humidity, wind, and rainfall; and system factors including equipments failure probability and cable connection problems. As a result, huge amount of computation and long computing time are usually required in current skills. Moreover, the accuracy of prediction result generated by applying current skills is not satisfactory.

### SUMMARY

One aspect of the present disclosure is related to a renewable energy power generation prediction system, which includes a measuring module and a control module. The measuring module is configured for measuring power generated by at least one renewable energy power generator and outputting a plurality of historical power values. The control module includes a computing unit and a machine-learning unit. The computing unit is configured for computing a plurality of historical power variations according to the historical power values. The machine-learning unit is configured for estimating a predicted power value according to the historical power variations.

Another aspect of the present disclosure is related to a renewable energy power generation prediction method, which includes the following steps: measuring power generated by at least one renewable energy power generator to generate a plurality of historical power values; according to the historical power values, compute a plurality of historical power variations; estimating a predicted power value according to the historical power variations.

One another aspect of the present disclosure is related to a power allocation system configured for allocating power generated by at least one renewable energy power generator to a plurality of power load devices, which includes a measuring module, a control module, and a load control module. The measuring module is configured for measuring power generated by at least one renewable energy power generator and outputting a plurality of historical power values. The control module includes a computing unit and a machine-learning unit. The computing unit is configured for computing a plurality of historical power variations according to the historical power values. The machine-learning unit is configured for estimating a predicted power value according to the historical power variations. The load control module is configured for comparing the predicted power value with a required load power value and controlling the power load devices. When the predicted power value is smaller than the required load power value, the load control module controls some of the power load devices to turn off or to receive additional external power. When the predicted power value is greater than the required load power value, the load control module controls some of the power load devices to turn on.

An advantage of applying the present disclosure is that by using historical power variations and machine-learning algorithms to predict values of power generated by renewable energy power generators, one can save huge amount of computation required in current skills due to considering many factors at the same time. For example, environmental factors include sunshine, temperature, humidity, wind, and rainfall; and system factors include equipments failure probability and cable connection problems. Therefore, the computing load and the computing time could be largely reduced. Moreover, experimental results show that the predicted power value generated by applying the present disclosure is more accurate than current skills.

These and other features, aspects, and advantages of the present disclosure will become better understood with reference to the following description and appended claims.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a schematic diagram of a renewable energy power generation prediction system in accordance with one embodiment of the present disclosure;

FIG. 2 is a flow chart of a renewable energy power generation prediction method in accordance with one embodiment of the present disclosure;

FIG. 3 is a schematic diagram of a power allocation system in accordance with one embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

As used herein, “around”, “about”, “approximately” or “substantially” shall generally mean within 20 percent, preferably within 10 percent, and more preferably within 5 percent of a given value or range. Numerical quantities given herein are approximate, meaning that the term “around”, “about”, “approximately” or “substantially” can be inferred if not expressly stated, or meaning other approximate values.

In the following description and claims, the terms “coupled” and “connected”, along with their derivatives, may be used. In particular embodiments, “connected” and “coupled” may be used to indicate that two or more elements are in direct physical or electrical contact with each other, or may also mean that two or more elements may be in indirect contact with each other. “Coupled” and “connected” may still be used to indicate that two or more elements cooperate or interact with each other.

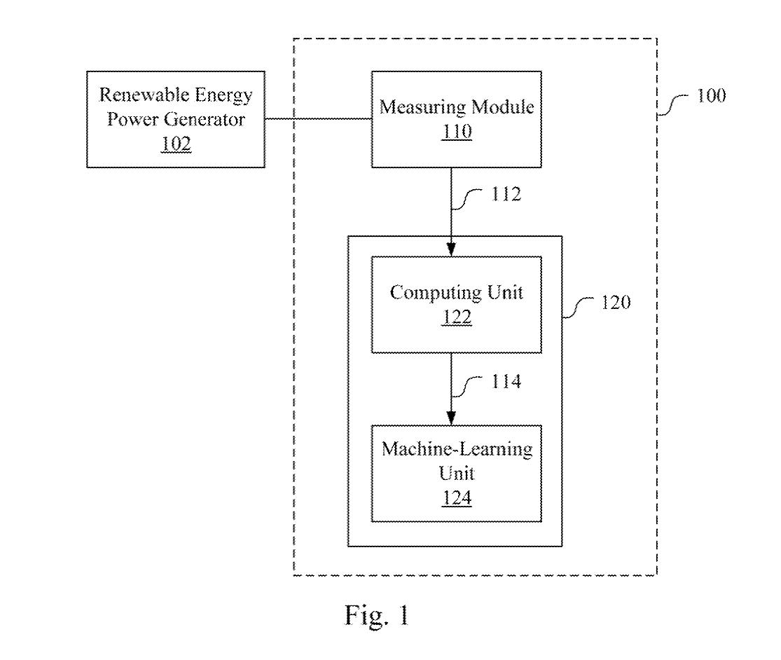

FIG. 1 is a schematic diagram of a renewable energy power generation prediction system 100 in accordance with one embodiment of the present disclosure.

The renewable energy power generation prediction system 100 is configured for predicting a value of power generated by at least one renewable energy power generator 102 at a future moment, in which the future moment could be any future moment, for example: one second later, one minute later, one hour later, one day later, or one week later.

In one embodiment of the present disclosure, the aforementioned renewable energy power generators 102 could include solar power generators, wind-driven generators, tidal power generators, geothermal generators, or hydroelectric generators. In an example, the aforementioned renewable energy power generators 102 include three solar power generators, two wind-driven generators and one geothermal generator.

The renewable energy power generation prediction system 100 includes a measuring module 110 and a control module 120. The measuring module 110 is configured for measuring power generated by the aforementioned renewable energy power generator 102, and outputting a plurality of historical power values 112. The control module 120 includes a computing unit 122 and a machine-learning unit 124. The computing unit 122 is configured for computing a plurality of historical power variations 114 according to the historical power values 112. The machine-learning unit 124 is configured for estimating a predicted power value according to the historical power variations 114.

In one embodiment, the historical power variations 114 are variations of two historical power values measured at two adjacent historical moments.

In another embodiment, the historical power variations 114 are computed by the following mathematical equations:

$$\frac{P ( t\_ 1 ) - P ( t\_ 2 )}{P ( t\_ 1 )} , \frac{P ( t\_ 2 ) - P ( t\_ 3 )}{P ( t\_ 2 )} , \frac{P ( t\_ 3 ) - P ( t\_ 4 )}{P ( t\_ 3 )} , … \frac{P ( t\_n - 1 ) - P ( t\_n )}{P ( t\_n - 1 )} ,$$

where n is a positive integer greater than 2, and P(t_{—}1), P(t_{—}2), P(t_{—}3), . . . P(t_n) are the historical power values 112 measured and generated by the measuring module 110 at a plurality of distinct historical moments t_{—}1, t_{—}2, t_{—}3, . . . t_n.

In an example, the renewable energy power generation prediction system 100 is predicting a value of power generated by the renewable energy power generator 102 at a future moment t. The estimation module 110 outputs the historical values of power P(t_{—}1), P(t_{—}2), P(t_{—}3), . . . P(t_{—}1000) generated by the renewable energy power generator 102 at one thousand past moments t_{—}1, t_{—}2, t_{—}3, . . . t_{—}1000. The computing unit 122 computes the following 999 historical power variations according to the aforementioned one thousand historical power values:

$$\frac{P ( t\_ 1 ) - P ( t\_ 2 )}{P ( t\_ 1 )} , \frac{P ( t\_ 2 ) - P ( t\_ 3 )}{P ( t\_ 2 )} , \frac{P ( t\_ 3 ) - P ( t\_ 4 )}{P ( t\_ 3 )} , … \frac{P ( t\_ 999 ) - P ( t\_ 1000 )}{P ( t\_ 999 )}$$

The machine-learning unit 124 performs an estimation procedure based on the 999 historical power variations and generate an estimation result P_{f}(t) as the predicted value of power generated by the renewable energy power generator 102 at a future moment t.

It has to be explained herein that the number of the aforementioned historical power values is not limited to 1000, and the number of the aforementioned historical power variations is not limited to 999. In an example, the computing unit 122 computes 300 historical power variations according to 500 historical power values.

in another embodiment, the machine-learning unit 124 employs a neutral network, a fuzzy neural network, a genetic algorithm, a particle swarm optimization algorithm, or a combination of the above four algorithms to estimate the predicted power values according to the historical power variations 114.

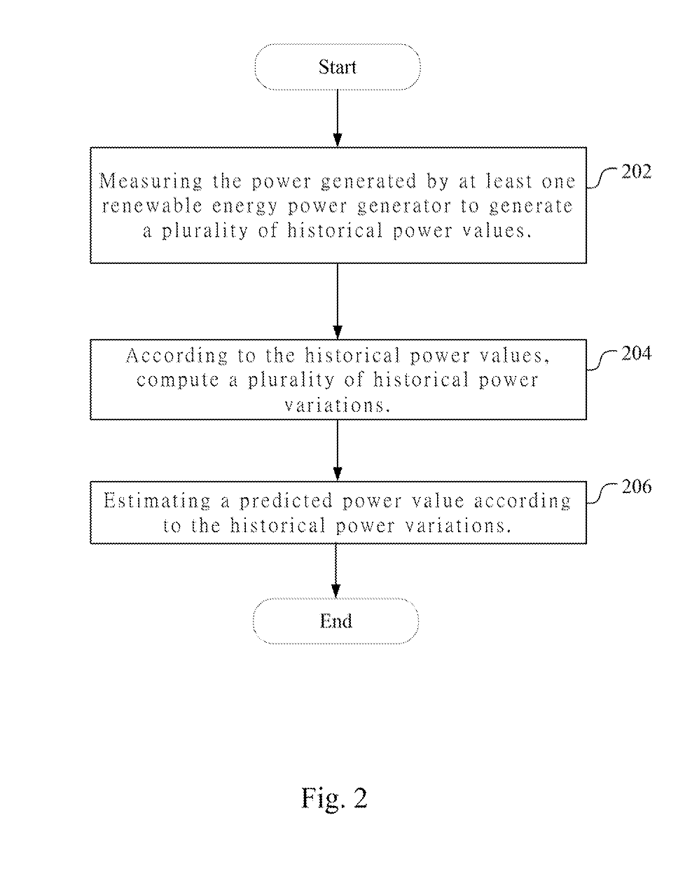

FIG. 2 is a flow chart of a renewable energy power generation prediction method in accordance with one embodiment of the present disclosure. The renewable energy power generation prediction method could be realized as a computer program product (for example, an application program), and could be saved in a computer-readable recording medium such that a computer could perform the renewable energy power generation prediction method after reading the recording medium.

The computer-readable recording medium could be a read only memory, a flash memory, a floppy disk, a hard disk, a disc, a USB flash drive, a tape, an internet-accessible database, or any computer-readable recording medium which could be thought of by skilled persons. The renewable energy power generation prediction method could be applied in the renewable energy power generation prediction system 100 illustrated in FIG. 1 and is not limited herein. For convenience and clarity, the following description about the renewable energy power generation prediction method is illustrated based on the renewable energy power generation prediction system 100 illustrated in FIG. 1

In step 202, the measuring module 110 measures the power generated by at least one renewable energy power generator 102 to generate a plurality of historical power values 112. In step 204, the computing unit 122 computes a plurality of historical power variations 114 according to the historical power values 112. In step 206, the machine-learning unit 124 estimates a predicted power value according to the historical power variations 114.

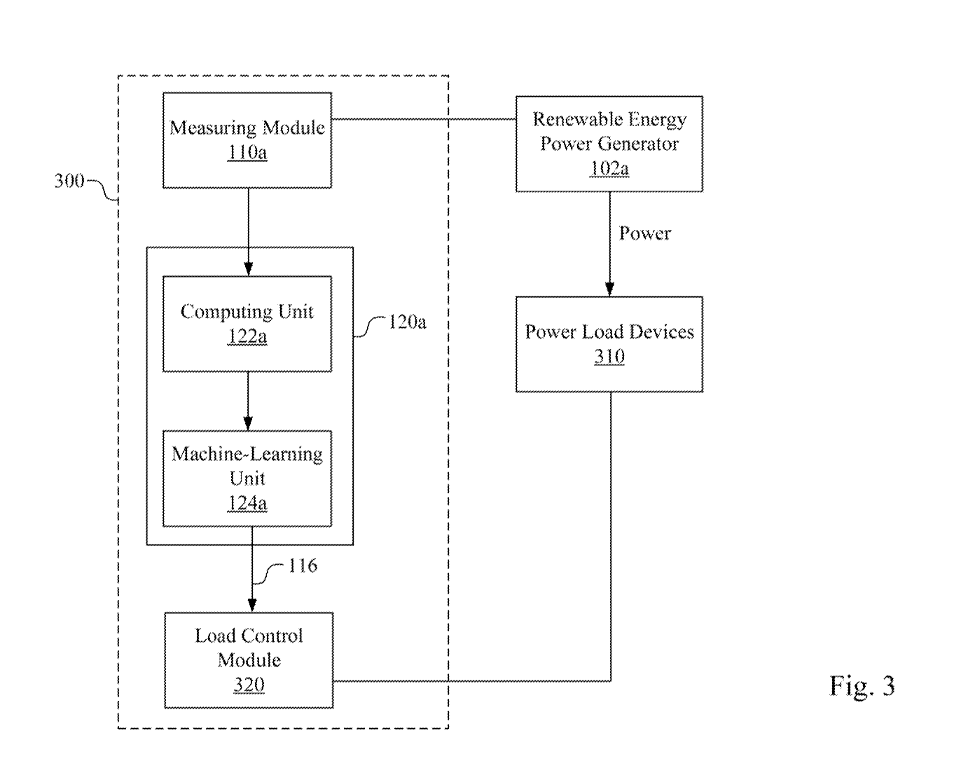

FIG. 3 is a schematic diagram of a power allocation system 300 in accordance with one embodiment of the present disclosure.

The power allocation system 300 is configured for allocating power generated by at least one renewable energy power generator 102a to a plurality of power load devices 310. The renewable energy power generator 102a could be the renewable energy power generator 102 illustrated in FIG. 1. Their functions and operations are similar and hence are not described again here.

In one embodiment, the power load devices 310 could include an air conditioner, a TV, an electric fan, an electric light, a computer, a hair dryer, a water dispenser, or any electricity-driven devices. In an example, the power load devices 310 include an air conditioner, a TV, an electric fan, and two computers.

The power allocation system 300 includes a measuring module 110a, a control module 120a, and a load control module 320. In which, the measuring module 110a, the control module 120a, the computing unit 122a, and the machine-learning unit 124a could be the measuring module 110, the control module 120, the computing unit 122, and the machine-learning unit 124 illustrated in FIG. 1, respectively. Their functions and operations are similar and hence are not described again here.

The load control module 320 is configured for comparing a predicted power value 116 outputted by the machine-learning unit 124a with a required load power value. When the predicted power value 116 is smaller than the required load power value, the load control module 320 controls some devices of the power load devices 310 to turn off or to receive additional external power (not depicted). When the predicted power value 116 is greater than the required load power value, the load control module 320 controls some devices of the power load devices 310 to turn on.

In one embodiment, when the predicted power value 116 is smaller than the sum of power required by the power load devices 310 at maximum load, the load control module 320 controls the power load devices 310 to turn off according to an unloading priority list until the predicted power value 116 is greater or equal to the sum of power required by the power load devices 310 at maximum load.

In an example, the power load devices 310 include an air conditioner, a TV, a computer, an electric fan, and an electric lamp. All the aforementioned devices are working based on the electricity provided by the renewable energy power generator 102a. When the predicted power value 116 is smaller than the sum of power required by the aforementioned devices at maximum load, the load control module 320 controls the aforementioned devices to turn off in the following order: the air conditioner, the electric fan, the TV, the computer, and finally the electric lamp, until the predicted power value 116 is greater or equal to the sum of power required by the remaining devices at maximum load.

For instance, if the predicted power value 116 is greater or equal to the sum of power required by the TV, the computer, and the electric lamp at maximum load after the air conditioner and the electric fan turning off, the control module 320 will not control the TV, the computer, and the electric lamp to turn off.

In another embodiment, when the predicted power value 116 is smaller than the sum of power required by the power load devices 310 at maximum load, the load control module 320 controls the power load devices 310 to receive an additional external power such that the power load devices 310 could function properly. In an example, the power load devices 310 include an air conditioner, a radio, a computer, and a fluorescent lamp. All the aforementioned devices are working based on the electricity provided by the renewable energy power generator 102a. When the predicted power value 116 is smaller than the sum of power required by the aforementioned devices at maximum load, the load control module 320 controls the aforementioned devices to receive municipal power such that these devices could function properly.

In one embodiment, when the predicted power value 116 is greater than the sum of power required by the power load devices 310 at maximum load, the load control module 320 controls the power load devices 310 to turn on according to a loading priority list until the sum of power required by the power load devices 310 at maximum load reaches the predicted power value 116.

In an example, the power load devices 310 include an air conditioner, a radio, a computer, a dehumidifier, and a fluorescent lamp. The fluorescent lamp and the computer are working based on the electricity provided by the renewable energy power generator 102a. When the predicted power value 116 is greater than the sum of power required by the fluorescent lamp and the computer at maximum load, the load control module 320 controls the air conditioner, the radio, and the dehumidifier to turn on in order until the sum of power required by the aforementioned devices at maximum load reaches the predicted power value 116.

For instance, if the sum of power required by the fluorescent lamp, the computer, the air conditioner and the radio at maximum load reaches the predicted power value 116 after the air conditioner and the radio turning on, he control module 320 will not control the dehumidifier to turn on.

In one embodiment, when the predicted power value 116 is greater than the sum of power required by the power load devices 310 at maximum load, the load control module 320 is further configured for controlling the renewable energy power generator 102a to output power to an external power network.

In an example, the power load devices 310 include an air conditioner, a refrigerator, a TV, and a fluorescent lamp. All the aforementioned devices are working based on the electricity provided by the renewable energy power generator 102a. When the predicted power value 116 is greater than the sum of power required by the aforementioned devices at maximum load, the load control module 320 controls the renewable energy power generator 102a to output power to a municipal power network.

In the aforementioned embodiments, by using the historical power variations and the machine-learning algorithms to predict the values of power generated by the renewable energy power generators, one can save huge amount of computation required in current skills due to considering many factors at the same time. For example: environmental factors include sunshine, temperature, humidity, wind, and rainfall; and system factors include equipments failure probability and cable connection problems. Therefore, the computing load and the computing time could be largely reduced. Moreover, experimental results show that the predicted power value generated by applying the present disclosure is more accurate than current skills.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A renewable energy power generation prediction system comprising:
a measuring module configured for measuring power generated by at least one renewable energy power generator and outputting a plurality of historical power values; and
a control module comprising
a computing unit configured for computing a plurality of historical power variations according to the historical power values; and
a machine-learning unit configured for estimating a predicted power value according to the historical power variations.

2. The renewable energy power generation prediction system of claim 1, wherein the historical power variations are variations of two historical power values measured at two adjacent historical moments

3. The renewable energy power generation prediction system of claim 1, wherein the historical power variations are computed by the following mathematical equations:
$$\frac{P ( t\_ 1 ) - P ( t\_ 2 )}{P ( t\_ 1 )} , \frac{P ( t\_ 2 ) - P ( t\_ 3 )}{P ( t\_ 2 )} , \frac{P ( t\_ 3 ) - P ( t\_ 4 )}{P ( t\_ 3 )} , … \frac{P ( t\_n - 1 ) - P ( t\_n )}{P ( t\_n - 1 )} ,$$
wherein n is a positive integer greater than 2, and P(t_{—}1), P(t_{—}2), P(t_{—}3), . . . P(t_n) are the historical power values measured at a plurality of distinct historical moments t_{—}1, t_{—}2, t_{—}3, . . . t_n.

4. A renewable energy power generation prediction method comprises:
measuring power generated by at least one renewable energy power generator to generate a plurality of historical power values;
according to the historical power values, compute a plurality of historical power variations;
estimating a predicted power value according o the historical power variations.

5. The renewable energy power generation prediction method of claim 4, wherein the historical power variations are variations of two historical power values measured at two adjacent historical moments.

6. The renewable energy power generation prediction method of claim 4, wherein the historical power variations are computed by the following mathematical equations:
$$\frac{P ( t\_ 1 ) - P ( t\_ 2 )}{P ( t\_ 1 )} , \frac{P ( t\_ 2 ) - P ( t\_ 3 )}{P ( t\_ 2 )} , \frac{P ( t\_ 3 ) - P ( t\_ 4 )}{P ( t\_ 3 )} , … \frac{P ( t\_n - 1 ) - P ( t\_n )}{P ( t\_n - 1 )} ,$$
wherein n is a positive integer greater than 2, and P(t_{—}1), P(t_{—}2), P(t_{—}3), . . . P(t_n) are the historical power values measured at a plurality of distinct historical moments t_{—}1 , t_{—}2, t_{—}3, . . . t_n.

7. A power allocation system configured for allocating power generated by at least one renewable energy power generator to a plurality of power load devices comprises:
a measuring module configured for measuring the power generated by the renewable energy power generators and outputting a plurality of historical power values; and
a control module comprising
a computing unit configured for computing a plurality of historical power variations according to the historical power values; and
a machine-learning unit configured for estimating a predicted power value according to the historical power variations; and
a load control module configured for comparing the predicted power value with a required load power value and controlling the power load devices, wherein when the predicted power value is smaller than the required load power value, the load control module controls some of the power load devices to turn off or to receive additional external power, and when the predicted power value is greater than the required load power value, the load control module controls some of the power load devices to turn on.

8. The power allocation system of claim 7, wherein the historical power variations are variations of two historical power values measured at two adjacent historical moments.

9. The power allocation system of claim 7, wherein the historical power variations are computed by the following mathematical equations:
$$\frac{P ( t\_ 1 ) - P ( t\_ 2 )}{P ( t\_ 1 )} , \frac{P ( t\_ 2 ) - P ( t\_ 3 )}{P ( t\_ 2 )} , \frac{P ( t\_ 3 ) - P ( t\_ 4 )}{P ( t\_ 3 )} , … \frac{P ( t\_n - 1 ) - P ( t\_n )}{P ( t\_n - 1 )} ,$$
wherein n is a positive integer greater than 2, and P(t_{—}1), P(t_{—}2), P(t_{—}3), . . . P(t_n) are the historical power values measured at a plurality of distinct historical moments t_{—}1, t_{—}2, t_{—}3, . . . t_n.

10. The power allocation system of claim 7, wherein the additional external power is municipal power.

11. The power allocation system of claim 7, wherein the required load power value is a sum of power required by the power load devices when the power load devices are at maximum load.

12. The power allocation system of claim 7, wherein the load control module controls the power load devices to turn off according to an unloading priority list.

13. The power allocation system of claim 7, wherein the load control module controls the power load devices to turn on according to a load priority list.

14. The power allocation system of claim 7, wherein when the predicted power value is greater than the required load power value, the load control module is further configured for controlling the renewable energy power generators to output power to an external power network.
